(19) United States
(12) Patent Application Publication
(10) Pub. No.: US 2019/0037779 A1
(43) Pub. Date: Feb. 7, 2019

(54) HORTICULTURAL CART WITH ADJUSTABLE TRELLIS SYSTEM

(71) Applicant: BruCo Products, LLC, Grand Rapids, MI (US)

(72) Inventor: Joseph Chirco, Grand Rapids, MI (US)

(21) Appl. No.: 16/053,110

(22) Filed: Aug. 2, 2018

Related U.S. Application Data
(60) Provisional application No. 62/540,686, filed on Aug. 3, 2017.

(51) Int. Cl. A01G 9/12; A01G 9/02; A01G 7/04

(52) U.S. Cl. CPC A01G 9/12; A01G 7/045; A01G 9/02

(57) ABSTRACT

A horticultural cart for supporting and training plant growth include a movable base structure. The base structure of the cart includes a bed portion that is configured to support a root system of a plant. A trellis is disposed over the bed portion of the base structure and is configured to support a shoot system of the plant. The trellis is rotatable to an angled orientation over the bed portion, such that the trellis is configured to align with a trellis of an adjacent cart for providing a valley shape that disperses light across the plants supported at the trellises from a light source disposed above the trellises.

### CROSS REFERENCE TO RELATED APPLICATION

The present application claims the filing benefits of U.S. provisional application Ser. No. 62/540,686, filed Aug. 3, 2017, which is hereby incorporated by reference herein in its entirety.

### FIELD OF THE INVENTION

The present invention generally relates to mobile horticultural support systems and devices, such as wheeled carts and the like, and more particularly to movable horticultural systems with a plant cultivation support structure or a trellis system or the like.

### BACKGROUND OF THE INVENTION

It is known to provide horticultural support structures with wheels, such as carts and wagons and the like, to allow the supported plants to be moved to different locations or growing environments. Typically, horticultural carts are used to transport plants that are being cultivated and trained, such as to transport plants short distances between indoor and outdoor locations or various plant environments, such as green houses or humidity controlled areas, where the carts may be sized to fit and traverse the plants through doorways and the like.

### SUMMARY OF THE PRESENT INVENTION

The present invention provides a horticultural cart and a corresponding cart system and trellis system for supporting and training plant growth, such as with the use of one or multiple adjacent carts that occupy a floor space in an indoor growing environment. It is, however, understood and appreciated that such a cart and cart and trellis system may be utilized in outdoor environments and may be utilized in both commercial and residential settings, such as for raised bed gardening and the like. The horticultural carts each have a bed portion that is configured to support a root system of a plant and an adjustable trellis that is configured to support a shoot system of the plant, such as the leaves or buds or the like, over the bed portion. The trellises may each have a width or grid area that is greater than the corresponding width of the cart or general floor space occupied by the cart. Accordingly, when multiple trellises are provided, such as when two horticultural carts are positioned adjacent to each other, the trellises may be positionable at an angled orientation relative to the respective bed portions, such as to provide a valley shape with the trellises, where the angled orientation is configured to more evenly disperse light intensity across the plants that are supported at the trellises from a light source or sources disposed above and generally centered between the trellises. Such light dispersion can increase growth production yields of these plants over the available lit floor space, and thus increase growing square footage and optimize light usage, while also providing increased accessibility to the plants. The cart and cart system may be used in indoor and outdoor environments and utilize artificial and/or natural light sources.

Optionally, at least one of the carts may include an arm that is configured to support the trellis away from the bed portion at a selected suspended height, such that the trellis may be rotatably coupled with the arm to position the grid at the angled orientation relative to the bed portion. Also, the trellises may be rotatable from the angled orientation to at least one of a horizontal orientation and a vertical orientation, such as to allow for increased access of the plants supported on the trellis and to allow for increased ease of transporting the carts. Optionally, the grid may also have differing shapes or undulations along the trellis to increase surface area of the grid that is capable of supporting the plants. Further, the trellis may have two or more grids substantially parallel to each other at a spaced distance from each other for supporting portions of the plant at different heights from the base structure.

According to one aspect of the present invention, a horticultural cart for supporting and training plant growth includes a movable base structure that is supported by a plurality of wheel assemblies. The base structure includes a bed portion that is configured to support a root system of a plant. A trellis is disposed over the bed portion of the base structure, where the trellis includes a grid that is configured to support a shoot system of the plant. An arm is attached between the base structure and the trellis to support the trellis at a selected suspended position over the bed portion. The trellis is rotatably coupled with the arm to position the grid at an angled orientation relative to the bed portion.

According to another aspect of the present invention, a horticultural cart system for supporting and training plant growth includes at least two carts. The first cart has a bed portion that is configured to support a root system of a first plant and an adjustable trellis supported over the bed portion and configured to support a shoot system of the first plant. The second cart has a bed portion that is configured to support a root system of a second plant and an adjustable trellis supported over the bed portion and configured to support a shoot system of the second plant. When the first and second carts are positioned adjacent to each other, the trellises of the first and second carts are both positionable at an angled orientation relative to the respective bed portions to provide a valley shape that is configured to disperse light across the first and second plants supported at the trellises from a light source disposed above the trellises.

According to yet another aspect of the present invention, a horticultural cart for supporting and training plant growth includes a movable base structure that is supported by a plurality of wheel assemblies. The base structure includes a bed portion that is configured to support a root system of a plant. A trellis is disposed over the bed portion of the base structure and is configured to support a shoot system of the plant. The trellis is rotatable to an angled orientation over the bed portion that is configured to align with a second trellis of an adjacent cart for providing a valley shape that disperses light across the plants supported at the trellises from an artificial light source disposed above the trellises.

According to a further aspect of the present invention, a method for supporting and training plant growth with an artificial light source includes providing at least two horticultural carts that each have a bed portion that is configured to support a root system of a plant and an adjustable trellis supported over the bed portion that is configured to support a shoot system of the supported plant. The trellises of the carts are each positioned at an angled orientation relative to the respective bed portions to provide a valley shape that is configured to evenly disperse light intensity across the plants supported at the trellises from the artificial light source disposed above the trellises.

These and other objects, advantages, purposes, and features of the present invention will become apparent upon review of the following specification in conjunction with the drawings.

### BRIEF DESCRIPTION OF THE DRAWINGS

FIG. 1A is a perspective view of a horticultural cart with an adjustable trellis system in accordance with the present invention;

FIG. 1B is another perspective view of the horticultural cart of FIG. 1A with a plant drainage tray removed from the cart;

FIG. 1C is an end perspective view of the horticultural cart shown in FIG. 1C with the trellis pivoted to a horizontal orientation;

FIG. 2 is a perspective view of two horticultural carts positioned adjacent to each other with the trellises oriented in a light absorption position at downward angles toward each other;

FIG. 3 is another perspective view of the two horticultural carts shown in FIG. 2;

FIG. 4 is an end elevational view of the two horticultural carts of FIG. 3 showing plants supported at the adjustable trellises and a light source providing light to the plants;

FIG. 5 is an end perspective view of the two horticultural carts of FIG. 3;

FIG. 6 is a side elevational view of the two horticultural carts of FIG. 3;

FIG. 7 is a top plan view of the two horticultural carts of FIG. 3;

FIG. 8 is a bottom plan view of the two horticultural carts of FIG. 3;

FIG. 9A is an end perspective view of additional embodiments of two horticultural carts positioned adjacent to each other with adjustable trellises in a light absorption position;

FIG. 9B is an end perspective view of the two horticultural carts of FIG. 9A with the trellises orientated at a further downward angle from the light absorption position;

FIG. 9C is an end perspective view of the two horticultural carts of FIG. 9A with the trellises orientated at upward angles toward each other;

FIG. 10 is a perspective view of an additional embodiment of a horticultural cart with an adjustable trellis having an angled grid;

FIG. 11 is an end elevational view of the horticultural cart shown in FIG. 10;

FIG. 12 is a side elevational view of the horticultural cart shown in FIG. 10;

FIG. 13 is a top plan view of the horticultural cart shown in FIG. 10;

FIG. 14 is a bottom plan view of the horticultural cart shown in FIG. 10;

FIG. 15 is a perspective view of an additional embodiment of two horticultural carts positioned adjacent to each other with adjustable trellises in a light absorption position;

FIG. 16 is another perspective view of the two horticultural carts shown in FIG. 15;

FIG. 17 is an end elevational view of the horticultural cart shown in FIG. 15;

FIG. 18 is a bottom plan view of the horticultural cart shown in FIG. 15;

FIG. 19 is an energy displacement graph provided over a planar floor surface;

FIG. 20 is an energy displacement graph when displacing the light energy over the trellises of FIG. 4 in the light absorbing position;

FIG. 21 is an end perspective view of an additional embodiment of two horticultural carts positioned adjacent to each other with adjustable trellises in a light absorption position;

FIG. 22 is a perspective view of a pivot locking device on one of the horticultural carts shown in FIGS. 22; and

FIG. 23 is another perspective view of the pivot locking device shown in FIG. 22.

### DETAILED DESCRIPTION OF EMBODIMENTS

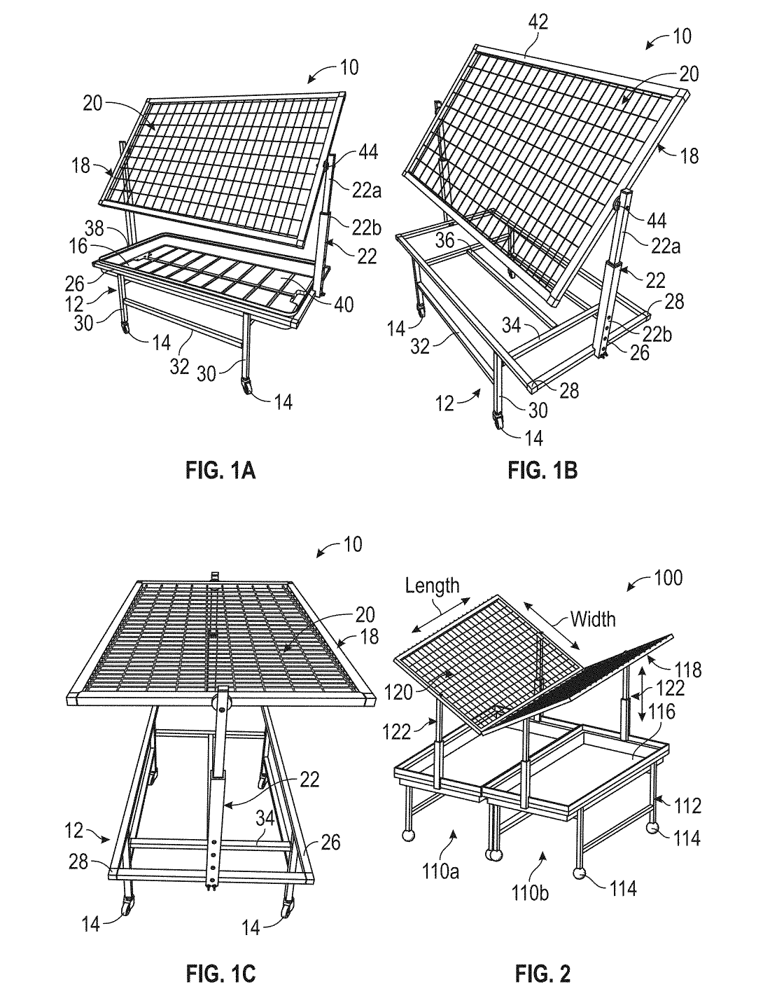

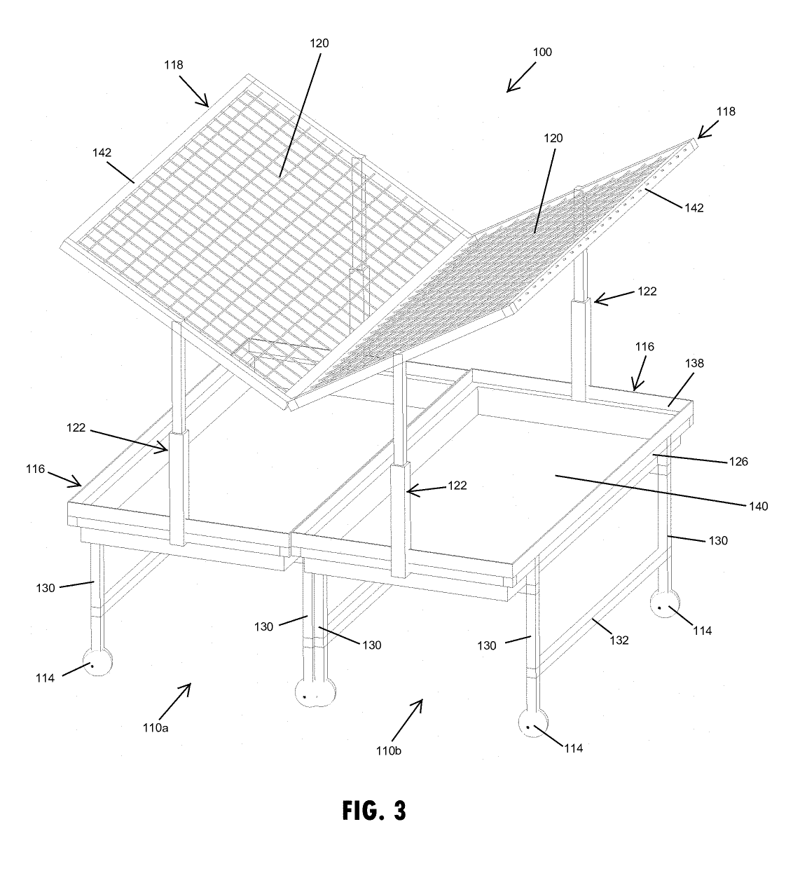

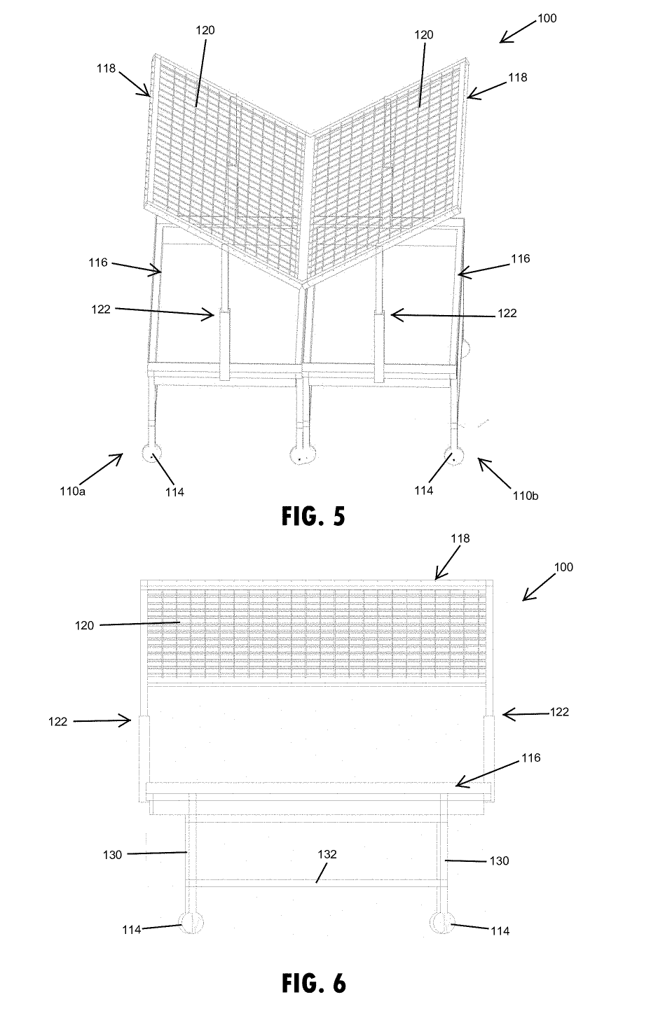

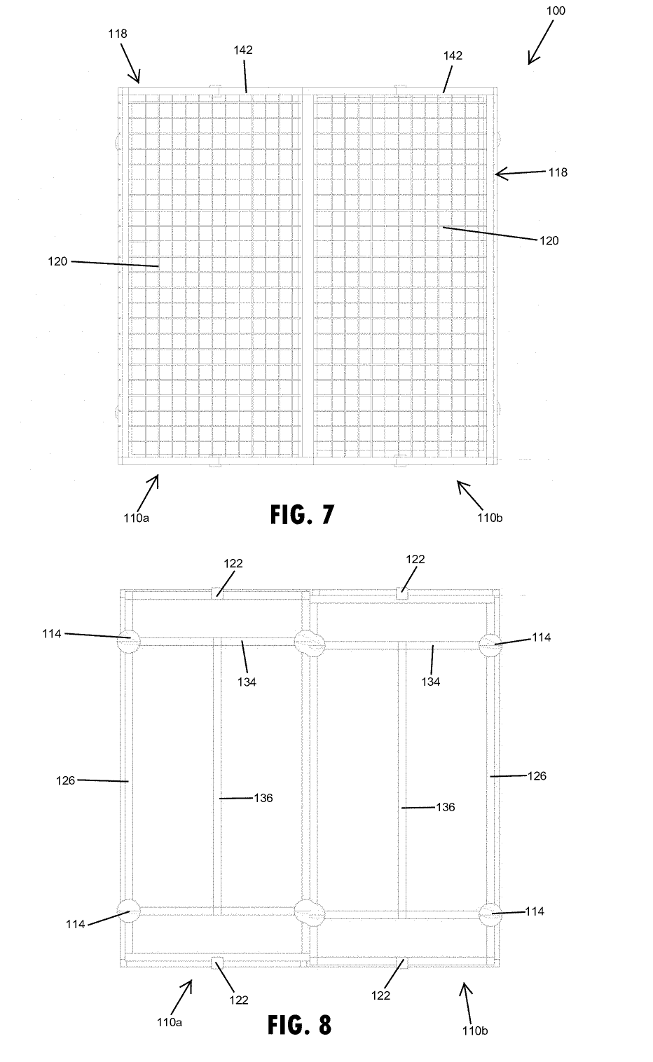

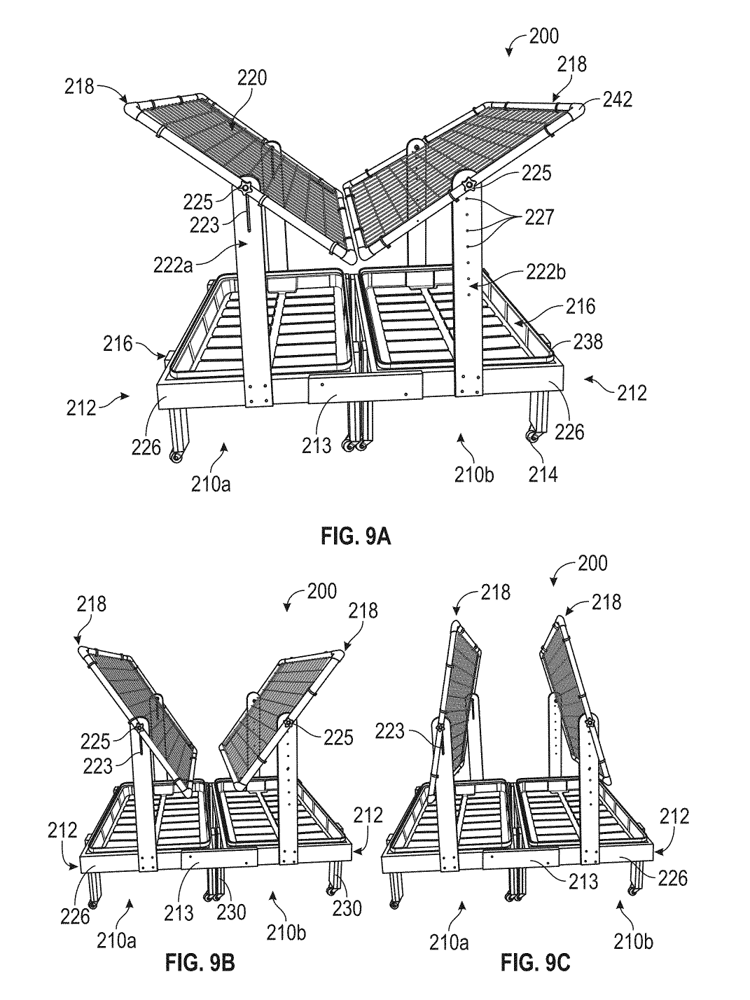

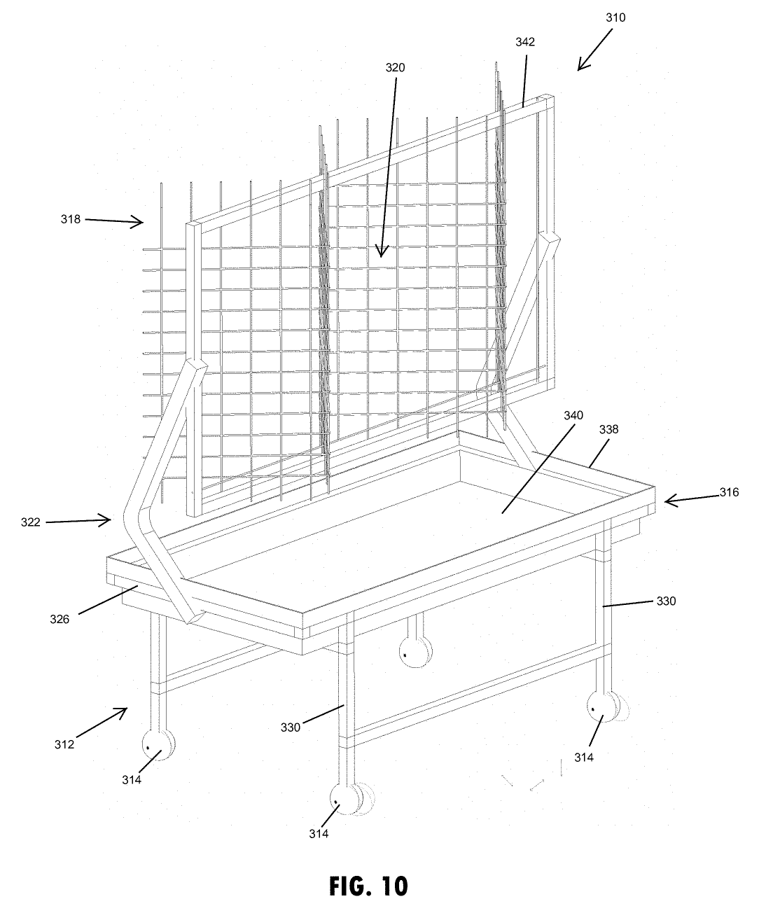

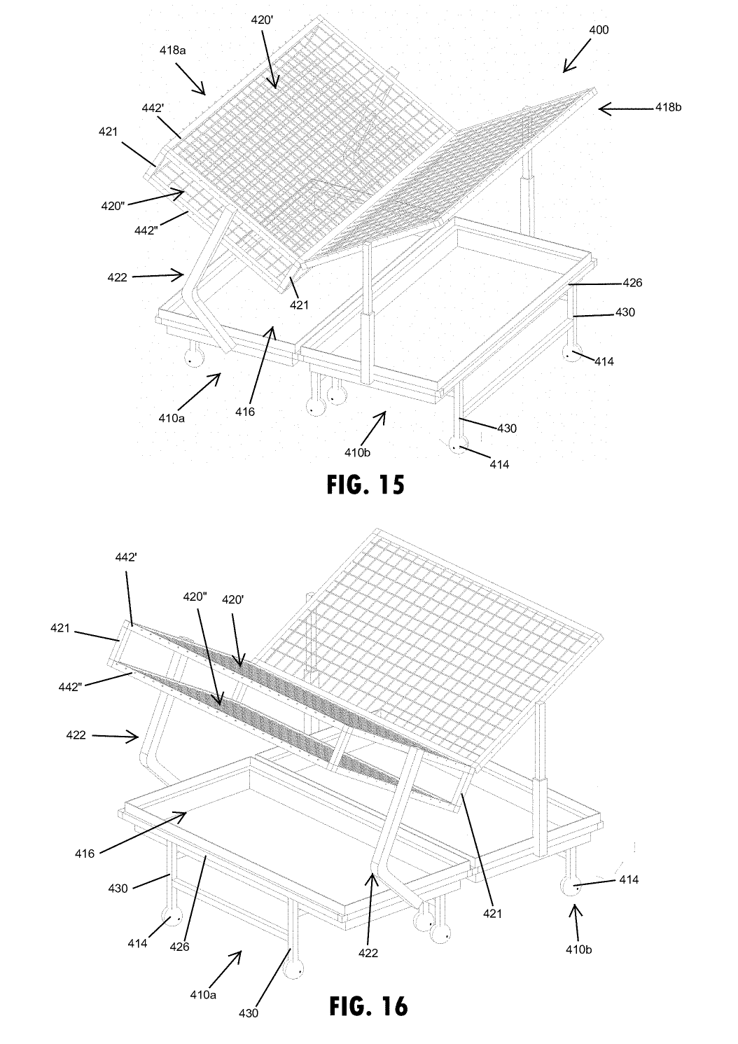

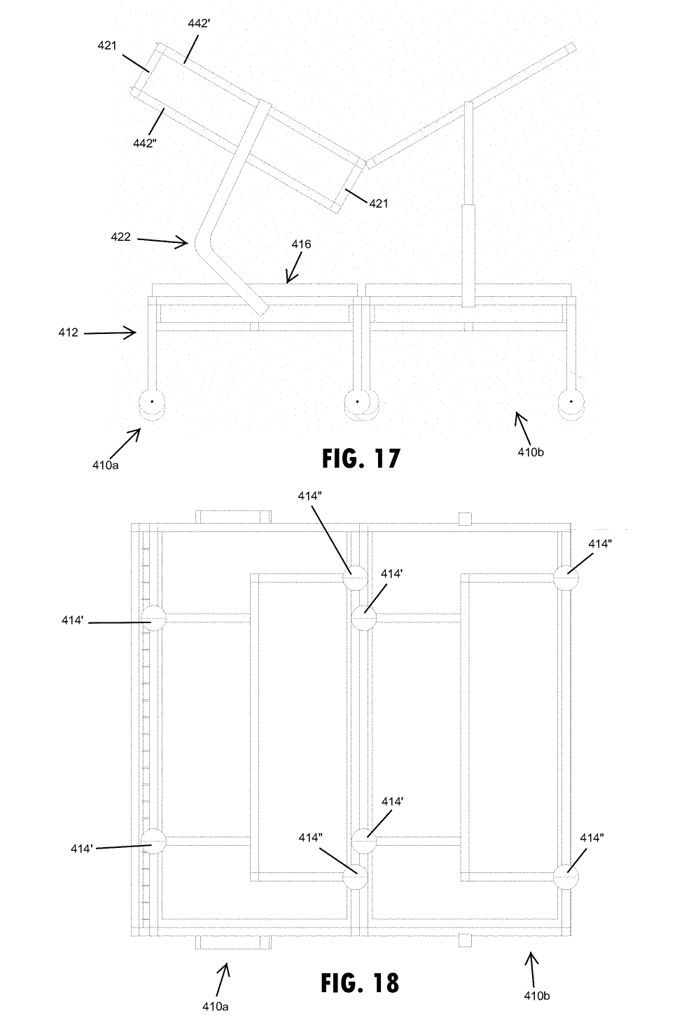

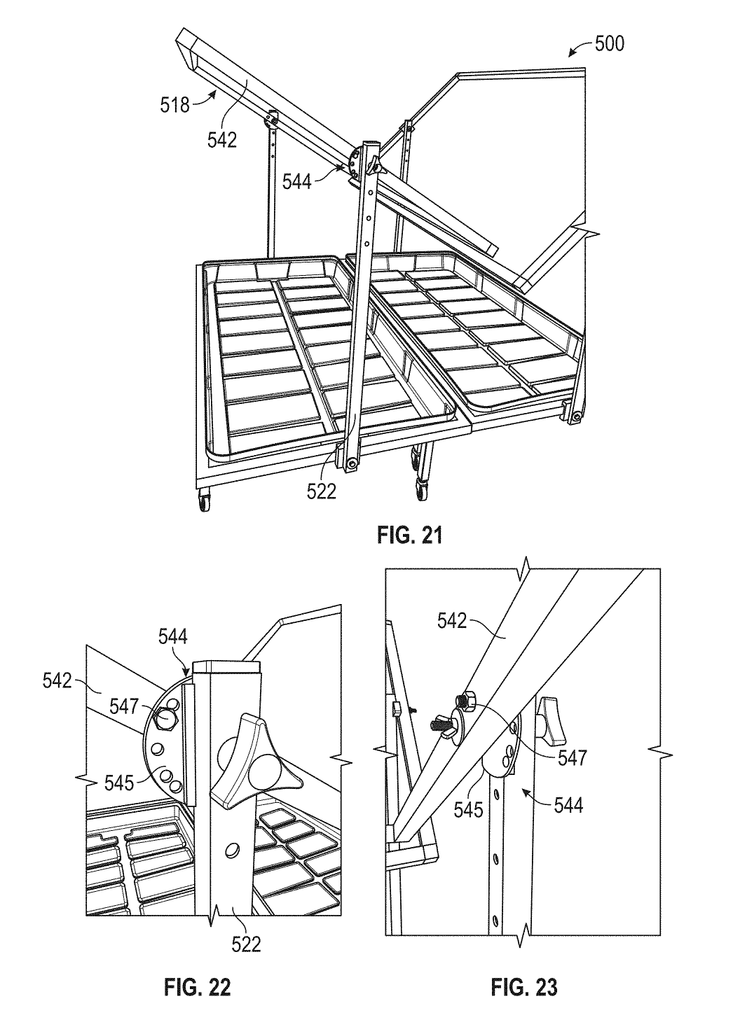

Referring now to the drawings and the illustrative embodiments depicted therein, a horticultural cart 10 (FIGS. 1A-1C) and a corresponding cart systems 100 (FIGS. 2-8), 200 (FIGS. 9A-9B), 400 (FIGS. 15-18), 500 (FIGS. 21-23) for supporting and training plant growth are provided, along with the associated methods of using such a cart and cart system. The horticultural cart 10 may include a movable base structure 12 that is supported by wheel assemblies 14. The base structure 12 may include a bed portion 16 that is configured to support a root system of a plant (FIG. 5). An adjustable growing canopy or trellis 18 may be disposed over the bed portion 16 of the cart 10, where the trellis 18 may have a plant support portion, such as a filament or wire grid 20, which is configured to support a shoot system of the plant, such as the stem, leaves, buds, blossoms, fruit, and the like. A canopy support or trellis arm 22 may be attached to extend between the base structure 12 and the trellis 18 for suspending the trellis 18 at a selected position or orientation over the bed portion 16 of the cart 10. The trellis 18 may also be is rotatably coupled with the arm 22, such as to position the grid 20 at an angled orientation relative to the bed portion 16. Also, the trellis 18 may be rotatable to various orientations, such as a horizontal orientation (FIG. 1C) and/or a vertical orientation (FIG. 10). In addition to increased yield from the optimal angled orientation, such rotational adjustment allows for improved access to the plants supported by the trellis 18 and increased ease of transporting the cart 10, such as for traversing through doorways or other relatively narrow passages with the trellis positioned in the vertical orientation.

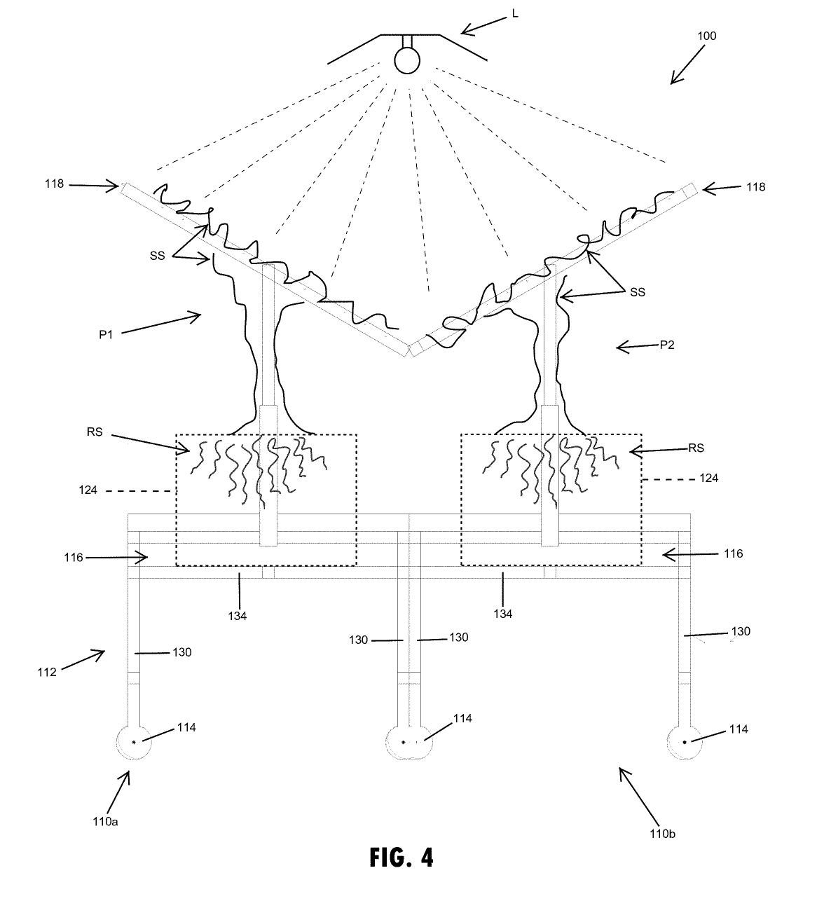

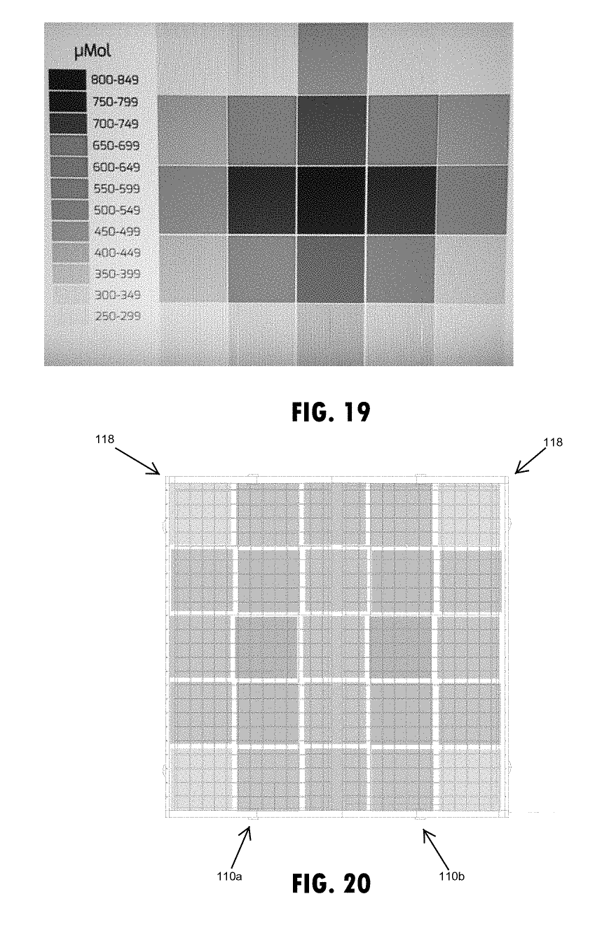

When the cart 10 is in use, it may be used with another cart, such as one that is similar or generally identical, where the two carts 110a, 110b (FIG. 2) may be positioned side-by-side, adjacent to each other and may be connected to each other, such as with zip tie fasteners. As such, the two adjacent carts may occupy a certain floor space or footprint area in the limited floor space of an indoor or outdoor growing or gardening environment. Such indoor growing can be advantageous for growing plants out of season or in otherwise undesirable geographic locations, as the growing conditions can be controlled and optimized, including the atmospheric temperature, atmospheric gases, light exposure intensity and time, among other conditions. With respect to lighting, indoor growing environments typically use an artificial light source or sources, such as a lamp L as shown in FIG. 4, to provide or supplement light that is appropriate for photosynthesis of the respective plant, such as high intensity discharge (HID) lights, light emitting diodes (LEDs), and florescent lights, or other known artificial light sources or combinations thereof. Thus, the floor space available for growing plants can be defined by the area on the floor space that is sufficiently lit by the natural or artificial light source or sources to facilitate or enable photosynthesis. For example, a light intensity map over a floor space is shown in FIG. 19 with the highest intensity being at the central area of the floor space, directly below and closest to the artificial light source. However, as shown in FIG. 20, the same light intensity from this artificial light source can be applied over the trellises 118 in the angled orientations, such as shown in FIG. 2, and the light intensity spreads out over the trellises 118 to provide a more even distribution of light intensity across the same floor area, while also increasing the surface area for plants to occupy for growth (at the angled trellises).

The bed portion 16, 116 of the horticultural cart 10, 110, as shown in FIGS. 1A and 2, is configured to support a root system of a plant and the adjustable trellis 18, 118 supported over the bed portion 16, 116 is configured to support a shoot system of the plant supported at the bed portion. For example, as shown in FIG. 4, the plants P1 and P2 each have a root system RS that is growing in a container 124, such as a box or pot or the like, that is generally supported by the bed portion 116 of the base structure 112, however, it is appreciated that the bed portion 116 may function as such a plant container, if desired. The bed portion 116 and/or container 124 can be configured to be used for soil gardening, hydroponic growing systems, aeroponic growing systems, among others. Further, as shown in FIG. 4, the shoot systems SS of the plants P1 and P2 each have a stem portion that is supported upright and leading to a leaf portion that is engaged at and supported by the plant support portion 120 of the trellis 118. For example, the shoot system SS of the plant may be woven through or supported to the screen 120 to cause increased auxin production and intermodal development of the plant. The trellises 118 may each have a width or grid area that is greater than the corresponding width of the respective horticultural cart 110a, 110b or the general floor space occupied by the cart.

Accordingly, when the horticultural carts 110a, 110b are positioned adjacent to each other, such as shown in FIG. 2 with the bed portions in abutting contact with each other, the trellises 118 are both positionable at an angled orientation relative to the respective bed portions, such as at downward angles toward each other to provide a valley shape, which may also be referred to as a light absorption position. This angled orientation is configured to more evenly disperse light intensity across the desired portions of the plants that are supported at or above the trellises 118. In doing so, the light source L disposed above and generally centered between the trellises 118 also increases the available light absorbing surface area from the floor space or foot print otherwise occupied by the carts 110a, 110b. Thus, the light dispersion to the angled trellises 118 can increase growth production yields of these plants over the available lit floor space per watt of energy used by the respective artificial light source.

Referring to the embodiment shown in FIGS. 1A-1C, the base structure 12 of the horticultural cart 10 includes an upper frame structure 26 that has four peripheral members attached together to form a rectangular shape, where ends of the peripheral members are attached at corner connectors 28. The base structure 12 also includes four legs 30 that are attached at the peripheral members of the upper frame structure 26 and extend down to engage the wheel assemblies 14. The wheel assemblies 14 may be a rigid or swivel caster or wheel or the like, and it is also contemplated that the legs may be adjustable in length. The legs 30 on the long sides of the cart 10 are supported by brace members 32 that attach between these two legs 30 and extend generally horizontally along the length direction of the cart 10. The base structure is further reinforced by two cross members 34 that each extend in the width direction of the cart between two of the legs 30. A floor support member 36 attaches centrally between the cross members 34, which are each secured at a generally equal height on the cart 10, so as to form a structure for supporting the bed portion 16.

The bed portion 16, such as shown in FIGS. 1A-1C, may have a basin or tray with a peripheral flange 38 that rests around the upper frame structure 26 and a floor portion 40 that rests on the cross members 34 and the floor support member 36. The basin may have a sloped floor that is configured to be angled relative to a ground surface engaged by the wheel assemblies 14, so as to drain water toward a center or side of the basin that may have a drain opening. The drain opening of the basin may also be attachable with a drain system for multiple carts, such as a docking station that drains to a gutter system or the like. Such a sloped floor of the basin may be integrally formed as part of the shape of the basin. Also or alternatively, the base structure 12 supporting the basin or tray may be offset or sloped to provide the sloped floor of the basin. Such a tray or basin may be an injection molded polymer or composite or a welded or stamped metal piece or other like material that provides a supportive structure for the plants carried by the cart. It is contemplated that the frame of the base structure in additional embodiments of the cart may be alternatively constructed with more or fewer members or by integrating the multiple pieces into a more unitary structure.

With further reference to FIGS. 1A-1C, the trellis 18 disposed over the bed portion 16 of the base structure 12 has a peripheral frame 42 that is generally rectangular in shape, although it is contemplated that additional embodiments of the cart may have no frame or an alternatively shaped trellis frame. The frame 42 is engaged around and borders the plant support portion of the trellis, such as the grid 20 that is configured to support a shoot system of the plant. The frame 42 may engage around a perimeter of the grid 20 to define a substantially planar grid area that is greater than an area defined by a periphery of the bed portion 16 of the base structure 12 or the upper structure 26 that generally supports the bed portion 16. Thus, the base structure 12 may include a width dimension that is less than a width dimension of the frame 42 of the trellis 18. The grid 20 of the trellis 18 may comprise a rigid wire or filament construction, such as a net or mesh, where the grid 20 may be fixed or removable from the trellis frame 42, such as a cut-away mesh grid or the like, which may be multiple interwoven filaments or a single filament woven into the frame. Also or alternatively, the grid may be secured to the trellis frame with a removable plastic connectors, such as zip ties that may be cut for removal of the grid from trellis, as may be desirable for harvesting growth embedded or supported on grid.

The trellis arms 22, as shown in FIGS. 1A-1C, are each attached between the upper frame structure 26 of the base structure 12 and the trellis frame 42 to suspend the trellis 18 over the bed portion 16 of the cart 10. The arms 22 may each include an upper section 22a that telescopically adjusts relative to a lower section 22b of the respective arm 22 for selecting a length of the arm 22 that provides the selected height or vertical spacing of the trellis 18 over the bed portion 16 of the cart 10. The lower section 22b of the arm 22 is shown rigidly fixed in an upright orientation at a central location along the width direction of the upper frame structure 26, such that the upper section 22a of the arm is received within a hollow interior of the lower section 22b to provide the telescopic adjustment. The telescopic adjustment may be locked so as to suspend the grid 20 away from the bed portion 16 of the base structure 12 at a selected height.

As further illustrated in FIGS. 1A-1C, the upper section 22a of the trellis arm 22 is rotatably coupled at a central location along the width direction of the trellis frame 42, so as to allow rotation of the trellis 18 relative to the arm 22 and thereby allow the trellis 18 to be positioned at an angled orientation relative to the bed portion 16. Similar to the height adjustment of the arms 22, the rotational adjustment of the trellis 18 may be locked or held in place by a locking device, such as two interfacing discs 44 (one fixed to the trellis and one fixed to the arm) that each have interlocking teeth that, when an intersecting fastener is tightened, the interlocking teeth on the discs 44 can mesh together to prevent movement at the rotational connection between the trellis and the arms 22, such as to lock the trellis at the angled, horizontal, or vertical orientations. It is contemplated that other forms of rotational locking devices may be also or alternatively be incorporated in additional embodiments of the horticultural cart. For example, as shown in FIGS. 21-23, a locking device 544 may be provided that includes a bracket 545 fixed to the arm 522 with apertures in the bracket 545 that correspond with selectable angular orientations of the trellis 518. The apertures may be engaged by a locking element, such as a fastener 547, which extends through the bracket 545 and engages the trellis frame 542 at the angled orientation that corresponds with the engaged aperture of the bracket. Alternatively, such a bracket may be fixed to the trellis and selectively engaged to the arm. As shown in FIGS. 21-23, the bracket is provided on the inside of the arm, between the trellis and the arm, although it is contemplated that alternative mounting locations may be utilized within the scope of this concept.

The structure of the cart 10 shown in FIGS. 1A-1C is made with square aluminum tubing that is welded and fastened together. However, it is contemplated that additional embodiments of the cart may also or alternatively be made of differently shaped members, such as round and/or solid cross-sections and may also or alternatively be made with other metals, polymers, composites, wood, such as cedar, and other generally known materials to provide a light weight structure capable of being manually pushed or moved.

Referring now to the embodiment shown in FIGS. 2-8, two carts 110a, 110b are positioned side-by-side, adjacent to each other so as to occupy a certain floor space with a light source, such as a lamp L, provided to grow or otherwise photosynthesize the plants supported by the carts. As shown, the trellises 118 each have a width or grid area that is greater than the corresponding width of the respective horticultural cart 110a, 110b or the general floor space occupied by the cart. To evenly disperse the light or light intensity to the plants supported at or over the trellises 118, the trellises 118 are positioned at an angled orientation relative to the respective bed portions at downward angles toward each other to provide a V-shape. As shown in FIG. 4, this angled orientation of the trellises 118 provides a more equal linear distance from the light source L that is generally centered between the carts 110a, 110b to the trellises 118 across the width of each trellis. Thus, the light source L disposed above and generally centered between the trellises 118 can an increased available light absorbing surface area on the trellises in comparison to the floor space or foot print otherwise occupied by the carts 110a, 110b.

With continued reference to FIGS. 2-8, the base structure 112 of the horticultural carts 110a, 110b includes an upper frame structure 126 that has four peripheral members attached together to form a rectangular shape. The base structure 112 also includes four legs 130 that are attached at the peripheral members of the upper frame structure 126 and extend down to engage the wheel assemblies 114. The wheel assemblies 114 may be a rigid or swivel caster or wheel or the like. The legs 130 on the long sides of each cart 110a, 110b are supported by brace members 132 that attach between these two legs 130 and extend generally horizontally along the length direction of each cart. The base structure 112 is further reinforced by two cross members 134 that each extend in the width direction of the cart between two of the legs 130. A floor support member 136 attaches centrally between the cross members 134, which are each secured at a generally equal height, so as to form a structure for supporting the bed portion 116.

The bed portion 116, as shown in FIGS. 2-8, has a basin or tray with a peripheral flange 138 that rests around the upper frame structure 126 and a floor portion 140 that rests on the cross members 134 and the floor support member 136. Further, the trellis 118 disposed over the bed portion 116 of the base structure 112 has a peripheral frame 142 that is generally rectangular in shape. The frame 142 is engaged around and borders the plant support portion of the trellis, such as the grid 120 that is configured to support a shoot system of the plant via the arms 122. The frame 142 engages around a perimeter of the grid 120 to define a substantially planar grid area that is greater than an area defined by a periphery of the bed portion 116 of the base structure 112. Thus, the base structure 112 includes a width dimension that is less than a width dimension of the frame 142 of the trellis 118. Unless stated or provided otherwise, features of the carts 110a, 110b shown in FIGS. 2-8 may be similar and therefore have been assigned like reference numbers to those described above and shown in FIGS. 1A-1C, with the addition of 100 to such reference numbers, such that description of these features above is generally applicable to this embodiment.

Referring now to the embodiment shown in FIGS. 9A-9C, two carts 210a, 210b are positioned side-by-side, adjacent to each other with the trellises 218 each having a width or grid area that is greater than the corresponding width of the base structure 212 of the respective cart or the general floor space occupied by the cart. To evenly disperse the light or light intensity to the plants supported at or over the trellises 218, the trellises 218 are positioned at an angled orientation relative to the respective bed portions, such as at downward angles toward each other in FIG. 9A to provide a V-shape. Thus, the angled trellises 218 can provide an increased available light absorbing surface area on the trellises in comparison to the floor space or foot print otherwise occupied by the carts 210a, 210b.

The embodiment shown in FIGS. 9A-9C also illustrates the base structure 212 of the horticultural carts 210a, 210b with an upper frame structure 226 that has four peripheral members, shown as wood boards, attached together to form a rectangular shape. The base structure 212 includes four legs 230 that are attached at the peripheral members of the upper frame structure 226 and extend down to engage the wheel assemblies 214. The carts 210a, 210b are interconnected at the base structures 212 by a connecting member 213 that attaches between the upper frame structures 226. The upper frame structure 226 supports the bed portion 216, as shown with a basin or tray having a peripheral flange 238 that rests around the upper frame structure 226.

As further shown in FIGS. 9A-9C, the trellis 218 disposed over the bed portion 216 of the base structure 212 has a peripheral frame 242 that is generally rectangular in shape and shown made of a PVC piping. The frame 242 is engaged around and borders the grid 220 that is configured to support a shoot system of the plant. The trellis 218 is supported by arms 222a, 222b that are each attached between the upper frame structure 226 and the trellis frame 242 to adjustably suspend the trellis 218 over the bed portion 216. The arms 222a of one cart 210a have a slot 223 at the upper portion of the arm that is engaged by a hand-adjustable fastener 225 that rotatably secures the trellis 218 to the arms 222a. The slots 223 can be utilized to adjust the selected height or vertical spacing of the trellis 218 over the bed portion 216 of the cart 210a. Similarly, the arms 222b of the cart 210b have a series of holes 227 disposed along a length of the arms 222b, where a select one of the holes 227 is engaged by a hand-adjustable fastener 225 that rotatably secures the trellis 218 to the arms 222. Thus, the holes 227 can be utilized to adjust the selected height or vertical spacing of the trellis 218 over the bed portion 216 of the cart 210b. Unless provided or stated otherwise, features of the carts 210a, 210b shown in FIGS. 9A-9C may be similar and therefore have been assigned like reference numbers to those described above and shown in FIGS. 1A-1C, with the addition of 200 to such reference numbers, such that description of these features above is generally applicable to this embodiment.

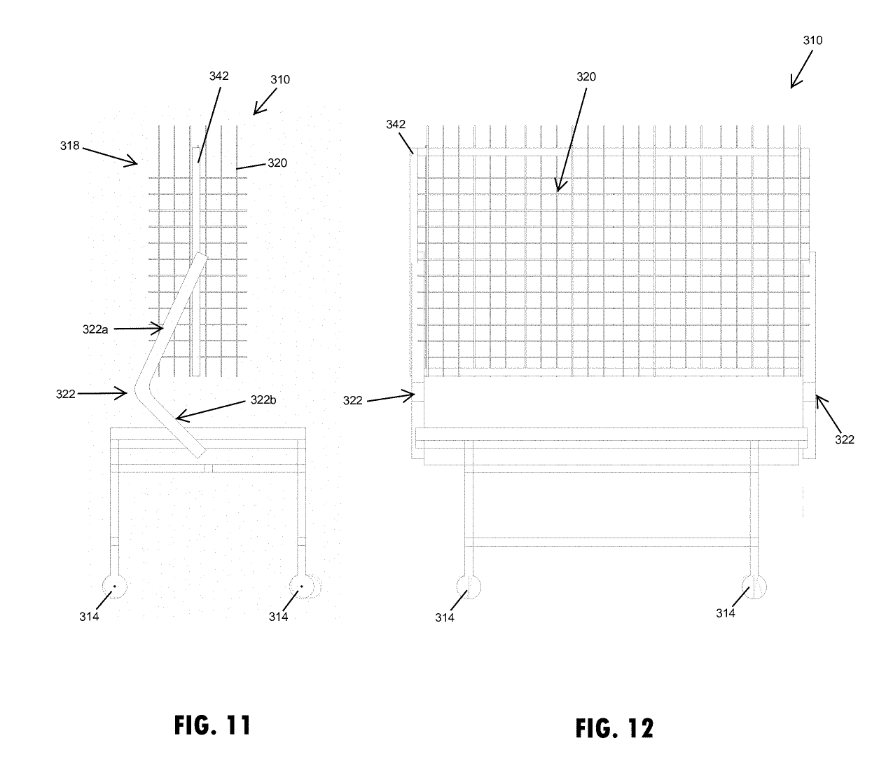

Referring now to the embodiment shown in FIGS. 10-14, the horticultural cart 310 has a base structure 312 that includes an upper frame structure 326 that has four peripheral members attached together to form a rectangular shape. The base structure 312 also includes four legs 330 that are attached at the peripheral members of the upper frame structure 326 and extend down to engage the wheel assemblies 314. The bed portion 316 has a basin or tray with a peripheral flange 338 that rests around the upper frame structure 326 and a floor portion 340 that rests on the cross members 334 and the floor support member 336.

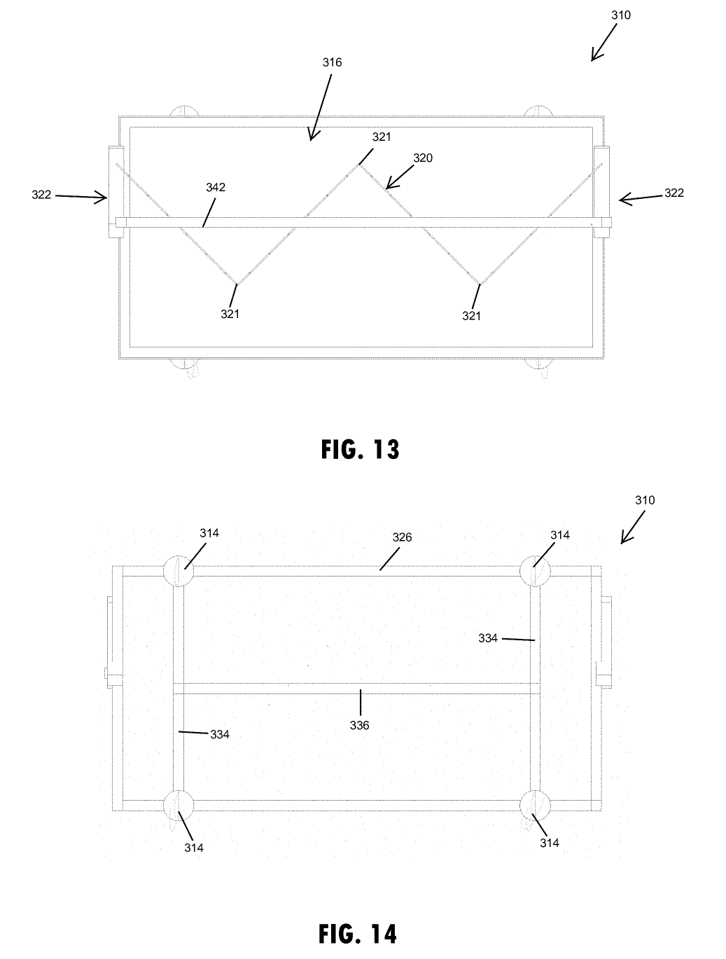

The trellis 318, as shown in FIGS. 10-14, is disposed over the bed portion 316 of the base structure 312 and has a peripheral frame 342 that is generally rectangular in shape. The frame 342, however, engages a grid 320 that has undulations along a length dimension of the frame 342 of the trellis 318. The illustrated undulations are wave-shaped with sharp V-shaped peaks 321 spaced generally equally along the wave shape, as shown in FIG. 13. The frame 342 engages the grid 320 at points between the peaks 321. The undulations in additional embodiments may alternatively be curved in shape or have irregular changes along length of the grid. The undulations are configured to increase surface area of the grid that is capable of supporting portions of the plant in a manner that receive light dispersed across the grid.

With further reference to FIGS. 10-14, the trellis 318 is supported by arms 322 that are each attached between the upper frame structure 326 and the trellis frame 342 to suspend the trellis 318 over the bed portion 316. The arms 322 illustrated in the embodiment shown in FIGS. 10-14 are angled to provide generally an L-shape or hockey stick shape, whereby the arms 322 include an upper section 322a that is angled relative to a lower section 322b of the arm 322. The upper section 322a is pivotally coupled with the trellis 318 to provide for rotatable adjustment of the trellis 318, such as to an angled orientation relative to the bed portion 316. The lower section 322b of the arm 322 is also pivotally coupled at the base structure 312, so as to allow the arm 322 to adjust the pivot point at the upper section 322a of the arm 322 forward and rearward over the cart. The angled lower section 322b may also be configured to contact a locking feature at the base structure 312 to lock the position of the arm 322 relative to the base structure 312. Unless provided or stated otherwise, features of the cart 310 shown in FIGS. 10-14 may be similar and therefore have been assigned like reference numbers to those described above and shown in FIGS. 1A-1C, with the addition of 300 to such reference numbers, such that description of these features above is generally applicable to this embodiment.

Referring now to the embodiment shown in FIGS. 15-18, two carts 410a, 410b are positioned side-by-side, adjacent to each other so the trellises 418a, 418b may be are positioned at an angled orientation relative to the respective bed portions at downward angles toward each other to provide a V-shape. As shown in FIGS. 15-18, the cart 410a includes arms 422 similar to those shown at 322 in FIGS. 10-14 and described above. However, the arms 422 are attached at the trellis 418a, such as in a fixed or pivotal manner. The trellis 418a includes two grids substantially parallel to each other at a spaced distance from each other that is configured to support portions of the plant at different heights from the bed portion 416. Each of the grids 420′ and 420″ are separately surrounded by a trellis frame 442′ and 442″ which are interconnected by corner connectors 421 that space and orient the grids relative to each other, and the grids 420′ and 420″ are pivotable together as a unit. The grids 420′ and 420″ may be pivotable as a unit with the arms 422 relative to the base structure or, in an alternative arrangement, may be pivotable together as a unit relative to the arms 422.

The base structure 412 of the horticultural carts 410a, 410b as shown in FIGS. 15-18 each include four legs 430 that are attached at the upper frame structure 426 and extend down to engage the wheel assemblies 414. The wheel assemblies 414 may be a rigid or swivel caster or wheel or the like. The wheel assemblies 414, as shown in FIG. 18, have a front set of wheels 414′ coupled with a front side of the base structure 412 at an offset location from a rear set of wheels 414″ coupled with an opposing rear side of the base structure 412 to configure the wheel assemblies 414 to mate against the adjacent horticultural cart 410b. Specifically, the illustrated cart 410a has the front wheels 414′ disposed inward on the cart from the rear wheels 414″, such that the front wheels 414′ of the cart 410b may be disposed inside the rear wheels 414″ of the cart 410a, when the carts are arranged as shown in FIGS. 15-18, thereby preventing the wheels from interfering with each other. Unless provided or stated otherwise, features of the carts 410a, 410b shown in FIGS. 15-18 may be similar and therefore have been assigned like reference numbers to those described above and shown in FIGS. 1A-1C, with the addition of 400 to such reference numbers, such that description of these features above is generally applicable to this embodiment.

Optionally, an automated watering system may be incorporated into an embodiment of the horticultural cart, such as drip emitters or the like disposed at the trellis arms or the trellis or other suitable locations that would be capable of emitting water to the plant's root system RS disposed at or supported by the bed portions. Also or alternatively, a manual watering system may be incorporated that provides an accumulation device, such as a funnel, at an elevated location, such as above the trellis or at the trellis arms, that is connected to tubing for depositing the water poured into the accumulation device directly to the soil of the plant. It is also contemplated that supplemental lighting may be provided at the trellis of an embodiment of the horticultural cart for providing light to leaves or other portions of the plant under the leaves held at the trellis and blocking light from contacting such leaves below the trellis. Furthermore, it is contemplated that electrical sensors, such as moisture, pH, light, and temperature sensors, may be installed at desired locations of an embodiment of the horticultural cart to monitor the growing conditions at the cart for further optimizing the growing process.

For purposes of this disclosure, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A horticultural cart for supporting and training plant growth, said horticultural cart comprising:
a movable base structure comprising a bed portion that is configured to support a root system of a plant;
a trellis disposed over the bed portion of the base structure, wherein the trellis includes a grid that is configured to support a shoot system of the plant; and
an arm attached between the base structure and the trellis to support the trellis at a selected suspended position over the bed portion, wherein the trellis is rotatably coupled with the arm to position the grid at non-parallel angled orientation relative to the bed portion.

2. The horticultural cart of claim 1, wherein the base structure comprises a plurality of wheel assemblies disposed below the bed portion, and wherein the bed portion of the base structure comprises a basin with a sloped floor that is configured to be angled relative to a ground surface engaged by the plurality of wheel assemblies.

3. The horticultural cart of claim 1, wherein the trellis comprises a frame that engages around a perimeter of the grid to define a grid area that is greater than an area defined by a periphery of the bed portion of the base structure.

4. The horticultural cart of claim 1, wherein the grid is positionable at different selectable heights above the bed portion of the base structure.

5. The horticultural cart of claim 4, wherein the arm includes a first section that telescopically adjusts relative to a second portion of the arm for selecting one of a plurality of different lengths of the arm corresponding to the different selectable heights of the grid.

6. The horticultural cart of claim 1, wherein the trellis is rotatable from the non-parallel angled orientation to at least one of a horizontal orientation and a vertical orientation.

7. The horticultural cart of claim 1, wherein the trellis in the angled orientation is configured to be positioned adjacent to a second trellis to form a V-shaped configuration that disperses light across the grids of the trellises from a light source disposed above the trellises.

8. The horticultural cart of claim 1, wherein the base structure includes a width dimension that is less than a width dimension of the frame of the trellis, and wherein the base structure is supported by a plurality of wheel assemblies.

9. The horticultural cart of claim 8, wherein the grid comprises undulations along a length dimension of the frame of the trellis, wherein the undulations provide a non-planar surface for supporting portions of the plant.

10. The horticultural cart of claim 1, wherein the arm comprises a lower arm section that is angled relative to an upper arm section, and wherein the lower arm section is pivotally coupled at the base structure.

11. The horticultural cart of claim 10, further comprising a locking feature at the base structure configured to selectively lock the position of the arm relative to the base structure.

12. The horticultural cart of claim 1, wherein the base structure comprises a plurality of wheel assemblies disposed below the bed portion, and wherein the plurality of wheel assemblies comprise a first set of wheels and a second set of wheels, wherein the first set of wheels is coupled with a first side of the base structure at an offset location from the second set of wheels coupled with an opposing second side of the base structure, wherein the first and second sets of wheels are configured to mate against an adjacent horticultural cart.

13. The horticultural cart of claim 1, wherein the trellis comprises a second grid substantially parallel to the grid at a spaced distance above the grid, wherein the grid and the second grid are configured to support portions of the plant at different heights from the base structure.

14. The horticultural cart of claim 13, wherein the grid and the second grid are rotatable together as a unit relative to the arm.

15. A horticultural cart system for supporting and training plant growth, said horticultural cart system comprising:
a first cart having a first bed portion that is configured to support a root system of a first plant, a first height-adjustable support arm extending upwardly from the first bed portion and an adjustable first trellis pivotably supported over the first bed portion by the first height-adjustable support arm and configured to support a shoot system of the first plant; and
a second cart having a second bed portion that is configured to support a root system of a second plant, a second height-adjustable support arm extending upwardly from the second bed portion and an adjustable second trellis pivotably supported over the second bed portion by the first height-adjustable support arm and configured to support a shoot system of the second plant;
wherein, when the first and second carts are positioned adjacent to each other, the first and second trellises are positionable at respective angled orientations relative to the respective first and second bed portions to provide a valley shape that is configured to facilitate light dispersal across the first and second plants supported at the first and second trellises from a light source disposed above and between the first and second trellises.

16. The horticultural cart system of claim 15, wherein the first and second trellises comprise respective frames that engages around a perimeter of a respective grid to define respective first and second grid areas that are greater than first and second bed areas defined by peripheries of the respective first and second bed portions.

17. The horticultural cart system of claim 15, wherein the first and second trellises are pivotable from the respective angled orientations to at least one of a horizontal orientation and a vertical orientation.

18. The horticultural cart system of claim 15, wherein the first and second carts each comprise a base structure having a width dimension that is less than a width dimension of the respective first and second trellis.

19. A method for supporting and training plant growth with an artificial light source, said method comprising:
providing at least two horticultural carts that each have a bed portion that is configured to support a root system of a plant, and an adjustable trellis supported over the bed portion that is configured to support a shoot system of the supported plant; and
positioning the trellises of the carts each at an angled orientation relative to the respective bed portions to provide a valley shape that is configured to evenly disperse light intensity across the plants supported at the trellises from the artificial light source disposed above the trellises.

20. The method of claim 19, further comprising adjusting a height of each adjustable trellis relative to the respective bed portion.
